(19) United States
(12) Patent Application Publication
(10) Pub. No.: US 2026/0079875 A1
(43) Pub. Date: Mar. 19, 2026

(54) DEBUG INFORMATION FLITS

(71) Applicant: Intel Corporation, Santa Clara, CA (US)

(72) Inventors: Mohannad Fahim Ali, San Jose, CA (US); Swadesh Choudhary, Mountain View, CA (US); Debendra Das Sharma, Saratoga, CA (US)

(73) Assignee: Intel Corporation, Santa Clara, CA (US)

(21) Appl. No.: 19/342,231

(22) Filed: Sep. 26, 2025

Related U.S. Application Data
(60) Provisional application No. 63/807,174, filed on May 16, 2025.

(51) Int. Cl. G06F 13/42; G06F 13/14

(52) U.S. Cl. CPC G06F 13/4221; G06F 13/14; G06F 2213/0026

(57) ABSTRACT

A device includes a port to couple to another device over an interconnect, where the port includes circuitry to generate a no operation (NOP) flit, where the NOP flit is encoded with debug information associated with an upper layer of a protocol stack. The generated NOP flit is then sent on the interconnect by the port.

### RELATED APPLICATIONS

This application claims benefit to U.S. Provisional Patent Application Ser. No. 63/807,174, filed May 16, 2025, which is incorporated by reference herein in its entirety.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects, have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of an interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates a first device coupled to a second device by an example link.

FIG. 6 illustrates an example no operation (NOP) Common Flit Header.

FIG. 7 illustrates an example payload of an example NOP empty flit.

FIG. 8 illustrates an example debug chunk.

FIGS. 9A-9C illustrate example debunk chunk formats.

FIG. 10 illustrates an example NOP.Debug Flit.

FIG. 11 illustrates a NOP.Debug Flit with multiple Debug Chunks.

FIG. 12 illustrates an example Empty Debug Chunk.

FIG. 13 illustrates an example Start Capture Trigger Debug Chunk.

FIG. 14 illustrates an example Stop Capture Trigger Debug Chunk.

FIG. 15 illustrates an example Debug Chunk with transmitter flow control information.

FIG. 16 illustrates an example Debug Chunk with receiver flow control information.

FIG. 17 illustrates an example Flit Mode Transmitter Retry Flags and Counters Debug Chunk.

FIG. 18 illustrates an example Flit Mode Receiver Retry Flags and Counters Debug Chunk.

FIG. 19 illustrates an example Buffer Occupancy Debug Chunk.

FIG. 20 illustrates an example Link Debug Request Debug Chunk.

FIG. 21 illustrates an example NOP.Vendor Flit.

FIG. 22 illustrates an example NOP Flit Control 1 Register.

FIG. 23 illustrates an example NOP Flit Control 2 Register.

FIG. 24 illustrates allocation of register fields in a NOP Flit Status Register.

FIG. 25 is a simplified block diagram illustrating an example protocol analyzer tool.

FIG. 26 illustrates an embodiment of a block diagram for a computing system including a multicore processor.

FIG. 27 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the principles and solutions discussed in this disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems and may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the solutions described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

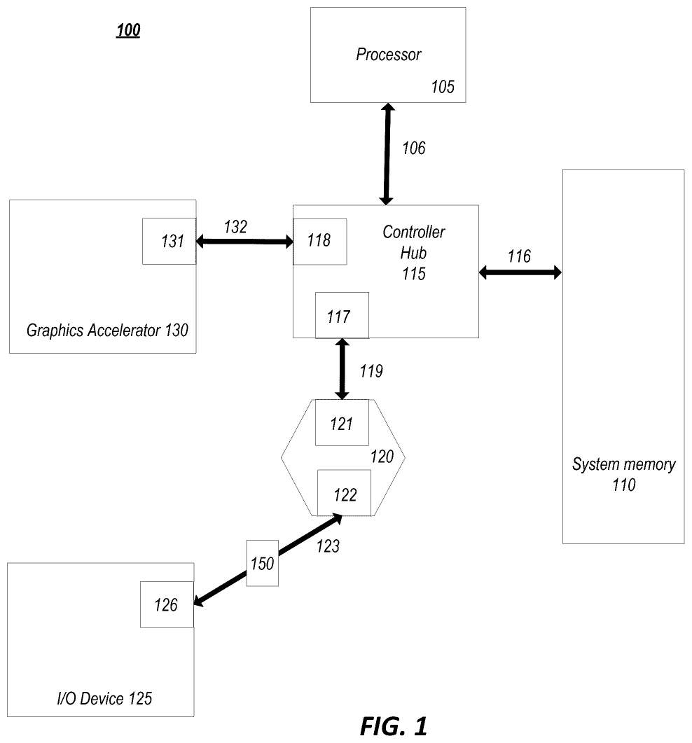

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, solid state memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. It should be appreciated that one or more of the components (e.g., 105, 110, 115, 120, 125, 130) illustrated in FIG. 1 can be enhanced to execute, store, and/or embody logic to implement one or more of the features described herein.

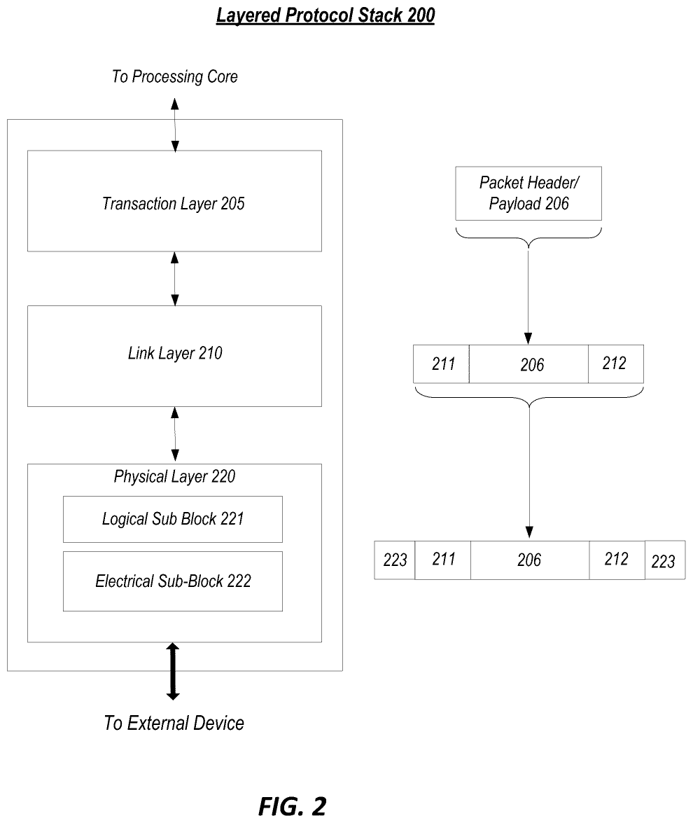

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

### Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-based flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message transactions are defined to support in-band communication between PCIe agents.

Therefore, in one embodiment, transaction layer 205 assembles packet header/payload 156. Format for current packet headers/payloads may be found in the PCIe specification at the PCIe specification website.

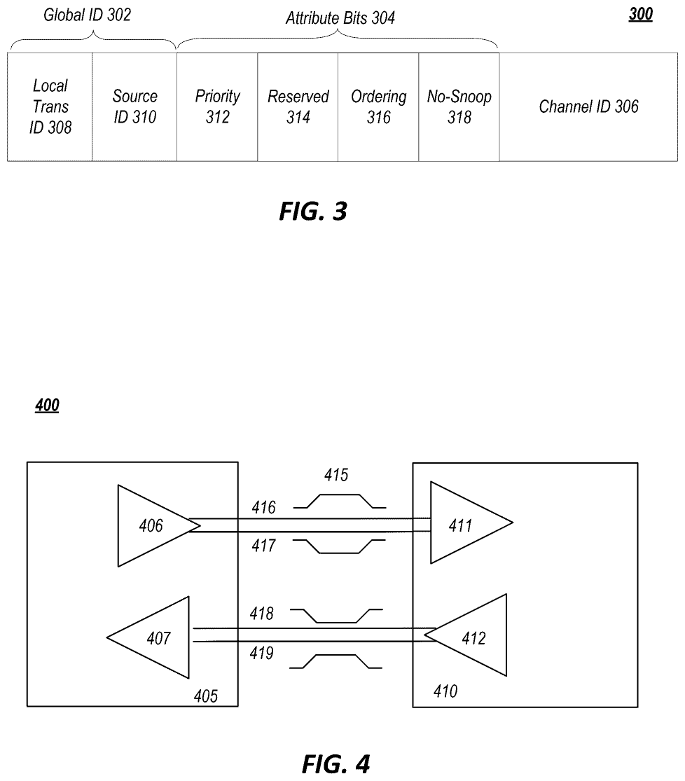

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

### Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

### Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., Displayport) may not and may even including only transmit or only receive pairs, among other examples.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

In PCIe, rapid advancements are taking place as the protocol evolves from generation 4.0 to generations 5.0 and 6.0. PCIe 4.0 may support 16 lane links with effective bandwidths of 64 GB/s and extended support for retimers and other features. PCIe 5.0 maintains the 16 lane link width, while doubling the effective bandwidth to 128 GB/s. To maintain these advances in bandwidth, PCIe 6.0 preserves the 16 lane link and adopts pulse amplitude modulation (PAM) encoding (e.g., PAM4 encoding), as opposed to PCIe's traditional non-return-to-zero (NRZ) encoding (e.g., 8b/10b, 128b/130b), to increase the number of bits that may be sent on a serial channel within a single unit interval (UI). Accordingly, PCIe 6.0 further doubles bandwidth to 64 GT/s from 32 GT/s in PCIe 5.0 thereby enabling 256 GB/s of bidirectional bandwidth. Such links may be valuably applied to couple devices such as a deep learning and artificial intelligence hardware accelerator devices; high speed graphic processor units, tensor processor units, and other deep learning processors; high-speed memory; and other hardware in a variety of emerging computing applications, from deep learning applications, autonomous vehicles, robotics, and high performance memory architectures, among other examples. PCIe 6.0 further includes low-latency Forward Error Correction (FEC) and other features to improve bandwidth efficiency, while maintaining backward compatibility with previous PCIe generations and similar channel reach to what is available in PCIe 5.0.

While high-speed PAM4 encoding allows links to realize new and improved applications, such links may be more susceptible to errors. In some implementations, a link and corresponding protocol may be configured to operate in multiple modes, such as a flit mode when high-speed PAM4 encoding is utilized and another (e.g., non-flit) mode when lower speed encoding (e.g., 8b/10b, 128b/130b NRZ) is used. For instance, a higher speed mode may utilize and particularly benefit from Forward Error Correction. Accordingly, a flit mode may be implemented, which subdivides the transmission of a single packet into a set of one or more defined flow control units, or “flits,” at the data link or logical PHY layer. However, such features may complicate parsing of the packet at the receiver. Each flit may include a respective header with information corresponding to the flit and packet, allowing some information traditionally reserved for the packet header to be omitted when redundant. In some implementations, two (or more) separate packet header formats may be defined for an interconnect (e.g., for PCIe 6.0-based interconnects), where a first packet header format is utilized for a mode utilizing flits for the packet transfer, and a different, second packet header format is utilized for a mode that does not utilize flits (e.g., a legacy mode defined in the protocol), among other example implementations. In some implementations it may be desirable to utilize flits for packet transfer when operating in lower speed modes (e.g., 8b/10b, 128b/130b NRZ).

In the case of PCIe, the transaction layer packet (TLP) header structure has evolved slowly but remained mostly unchanged. With the adoption of PAM4 encoding and a shift to flit-based data integrity with PCIe 6.0, a new, revised TLP header format may be utilized. The new, flit-mode TLP header may also address the reality that existing PCIe TLP headers lacks remaining reserved bits to expand the features and information, which may be communicated in corresponding packet header fields. In one example implementations, a flit-mode TLP header may replace the traditional, orthogonal, Format (Fmt) and Type fields to a fully-decoded 8-bit TLP Type field, which may be encoded with values to indicate all (or considerably all) existing TLP Types in PCIe, while adding new TLP types for no-op (NOP) and End Bad (EDB) packets types. Indeed, with flit mode, any number of NOP TLPs may be transmitted before or after any other TLP, with NOP TLPs discarded without effect by the receiver. Further the flit-mode TLP header may add new expanded header elements to include what had previously been communicated using TLP Prefixes and other mechanisms in PCIe, including Process Address Space Identifier (PASID), TLP Processing Hints, and Secure TLPs, among other examples. Other example modifications may include the addition of an 8-bit Segment ID (SBDF) to Requester and Completer ID, increasing the Tag field bits (e.g., 12, 14, or 16 bits), removing outdated fields and elements (e.g., the “Byte Count” field), among other example modifications.

Among the example benefits, which may be realized through a flit-mode packet header, the header may provide the ability for the receiver's transaction layer to robustly parse incoming TLP content without relying on TLP demarcation information from the Physical or Data Link Layers. As another example, extensibility of packets may be better facilitated via a flexible TLP structure consisting of a TLP Header Base followed by flexibly added additional header content (e.g., zero to 7 additional double words (DW) of content). In one example, the PCIe Transaction Digest may be replaced in flit mode packets by a “Trailer” of zero to 3 DW. In some implementations, the first DW of the Header Base includes all information requisite to determine the full size of the TLP, including the Header itself, any data payload, and the Trailer, if present. The End Bad (EDB) and Poisoned TLP mechanisms may also be modified, and in flit mode indicated via Suffixes which, if present, immediately follow the TLP to which they apply, and which, for Poisoned, are conveyed end-to-end with the TLP through Root Complexes that support peer-to-peer and all switches. Further, all TLP Type encodings defined for flit mode headers may be assigned flow control and routing for “forwards compatibility,” such that new opcodes can be allocated without requiring modification to existing switch and the generic blocks of PCIe controller hardware.

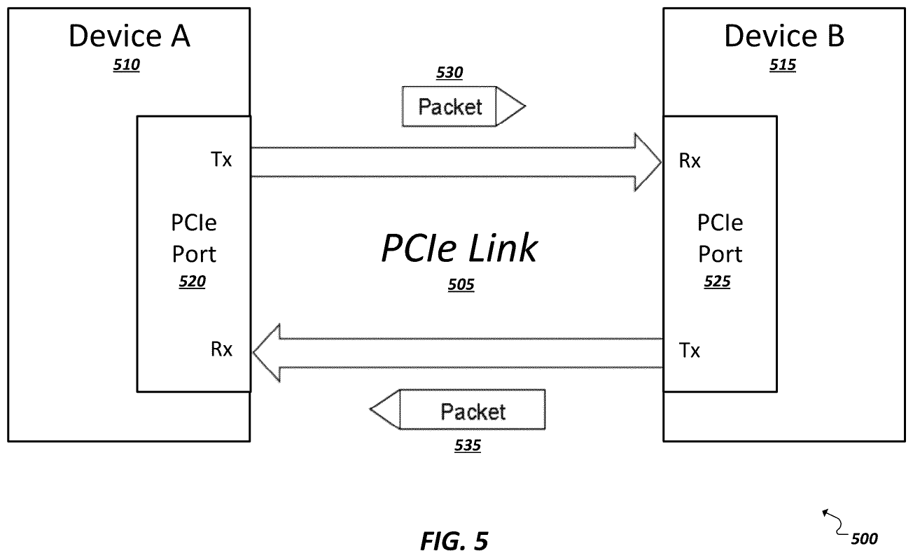

Turning to FIG. 5, a simplified block diagram 500 is shown illustrating an example PCIe link 505 coupling a first device 510 to a second device 515. Each of the devices 510, 515 may be equipped with one or more multiple ports (e.g., 520, 525) to support one or more multiple connections to other devices (e.g., on the same or different die or package). The port (e.g., 520, 525) may include transmit and receive circuitry as well as logic (e.g., implemented in hardware circuitry) to implement one or more interconnect protocols governing operation of a corresponding connection. For instance, ports 520, 525 may each include circuitry to implement a layered protocol stack of a PCIe-based protocol. The PCIe protocol (e.g., PCIe 6.0) may support both a flit mode and another non-flit mode. The corresponding protocol circuitry (e.g., of ports 520, 525) may be utilized to generate packets (e.g., 530, 535) with packet headers according to each of the flit mode and non-flit mode, such as discussed in the examples herein. Likewise, protocol logic at the devices 510, 515 (e.g., corresponding to the receivers of the ports 520, 525) may receive packets (e.g., 530, 535) generated and sent by another device and utilize information within the packets to identify boundaries of the packet and parse the packet and its contents (e.g., using fields such as discussed in the examples below).

As introduced above, in flit mode, the link may be configured to robustly parse incoming TLP content without relying on TLP demarcation information from the Physical or Data Link Layers. In addition, flit mode PCIe TLP headers may include several changes over traditional PCIe TLP headers to improve extensibility compared to these non-FLIT mode header structures where all reserved bits are consumed. Indeed, in some cases, the lack of remaining space in traditional PCIe TLP headers may result in implementations where information is mixed between the header itself and TLP prefixes, among other example issues. In an example flit mode, link local TLP prefixes may be preserved, but end-to-end TLP prefixes are removed and replaced with a more flexible TLP structure consisting of a defined TLP header base optionally followed by 0-7 additional DW of header content. Further, in some implementations, the PCIe Transaction Digest mechanism is replaced by a “Trailer” of 0-3 DW. In one example, the first DW of the flit mode header base may be formatted to include all information requisite to determine the full size of the TLP, including the header itself, any data payload, and any trailer if present.

In traditional system, debugging PCIe components often involves diagnosing issues across different layers of the stack, which can be challenging. Debugging often relies on a combination of protocol analyzers and implementation-specific sideband interfaces to attempt to gain visibility into internal logic and signals which can be difficult to correlate with activity on the PCIe link. This process is not only time-consuming but also challenging, especially when trying to pinpoint issues in real-time, among other example issues. In an improved implementation, the transmission of debug information may be standardized in accordance with a corresponding protocol definition (e.g., compliant with a PCIe protocol standard), for instance, by transmitting debug information directly over the link (e.g., a PCIe link) using no operation (NOP) flits. This allows debug data to be seamlessly interleaved with functional packets, ensuring that diagnostic information flows continuously without disrupting normal system operations. By defining standardized and vendor-specific debug content, it can be ensured that the transmitted data is both relevant and actionable, providing a clear baseline for what vendors should implement. This approach may operate independently of the upper layers of the stack, making it possible to debug issues even when those layers are malfunctioning as long as the physical layer is functional. This streamlines the debugging process, enabling more efficient real-time diagnostics and improving the overall reliability and performance of PCIe systems, among other example advantages.

As an example, in one implementation, two new standardized versions or types of NOP flits may be defined in a protocol, including a NOP.Debug flit for transmitting debug information and a NOP. Vendor flit for exchanging vendor-specific content. An existing NOP flit (e.g., which is typically sent with empty or null fields), may be designated as a NOP.Empty flit. This set of NOP Flit types can be transmitted freely, without being subject to replay or flow control, enabling a best-effort delivery of in-line debug data. A NOP flit counter may also be implemented to help detect missing NOP Flits, and a NOP Stream ID may be used to identify the origin and facilitate forwarding use cases, enhancing the efficiency and reliability of real-time system debugging, among other example features. A mechanism is added for software to trigger the release of specific requested debug information, among other example implementations.

An improved system implementing NOP flits for the transmission of debug information may significantly enhance the debugging capabilities and speed for vendors and their customers by providing a standardized method to transmit debug information directly over PCIe links. Further, information concerning an upper layer of a port (e.g., an transport layer, protocol layer, application layer, etc.) may be collected at the port (e.g., using monitors configured to decode the protocol layer information, check compliance with protocol layer rules and formats, and identify other information concerning compliance with and performance of the protocol layer), and this information may be bundled as debug information for inclusion with specialized NOP flit fields. By defining standardized debug chunks and enabling the transmission of internal logic and signals over the link, it simplifies the determination of correlation between internal states and PCIe activity, reducing reliance on protocol analyzers and sideband interfaces. This standardization not only sets a baseline for vendor implementation, facilitating field debugging, but also accelerates internal debugging processes, ultimately improving system reliability and reducing time-to-resolution for complex issues, among other example features and advantages.

Debug information may be collected from a variety of system components or protocol layers and include information such as credit counters, buffer occupancy, retry flags. Other debug information may be included, which is vendor- or implementation-specific, allowing for an expansive array of types of debug information to be able to be included in a NOP debug flit. Such information may be collected for inclusion in a NOP flit, for instance, based on a software trigger (e.g., through a register), according to a defined interval (e.g., allowing a chuck of debug information to be sent according to a regular frequency (e.g., number of cycles), or based on an event trigger (e.g., debug information collected based on detection of an error condition or other issue), among other examples.

The NOP Flit debug mechanism allows for transmitting debug information over the PCI Express link. It utilizes NOP.Debug and NOP.Vendor Flit types, which are inherently non-intrusive and conform to existing PCI Express flit transmission rules, to deliver the debug information across the link. This mechanism can be particularly useful for capturing real-time link information, which is vital for debugging transient issues that are not easily accessible or visible after their occurrence.

Both NOP.Debug and NOP.Vendor Flits can provide visibility of internal state information to an observer. Internal states could be related to the PCI Express Link used for sending these NOP Flit types or it could be something unrelated to the PCI Express Link. Possible Observers include implementation specific entities in the receiving Port and external Protocol/Logic Analyzers, allowing for real-time analysis of link behavior. This immediate access to link information can be important for diagnosing issues that may only be present for a brief period, allowing that critical debug data is not missed or stale.

NOP Flits are transmitted by the Physical Layer, functioning independently from the upper protocol layers with respect to their transmission. While the content encapsulated within these NOP Flits may be derived from, informed by, or provided by the upper layers, such as the Data Link or Transaction Layers, the actual process of sending these Flits is managed at the Physical Layer level. This separation ensures that the debug information can be transmitted even in scenarios where the upper layers may not be fully operational or are in a state of initialization.

NOP.Debug flits or NOP. Vendor flits can be transmitted periodically during normal operation as a proactive measure serving as checkpoints, as an early indicator preceding potential error conditions, in direct response to error conditions that have been detected, or manually triggered. As one example, NOP.Debug flits or NOP.Vendor flits may be subject to periodic transmission. By periodically transmitting the current state of the link when no error conditions are present, the NOP.Debug Flits can serve as valuable checkpoints when debugging a failure and trying to identify the failure point with respect to regular link traffic. As another example, NOP.Debug flits or NOP.Vendor flits may be sent as a precursor to error conditions. For instance, the transmission of NOP.Debug Flits may be triggered as a preemptive signal when the system identifies patterns that typically precede error conditions, alerting an observer to the state of the link and providing context for debugging. As another example, NOP.Debug flits or NOP. Vendor flits may be sent in response to detected error conditions. For instance, in the event of an error, NOP.Debug Flits can be transmitted immediately to capture the state of the link at the time of the error, providing valuable context for debugging. As yet another example, NOP.Debug flits or NOP. Vendor flits may be sent in accordance with a manual trigger, such as the software-initiated transmission of NOP.Debug Flits to allow for on-demand generation of debug information, giving the ability to manually trigger NOP.Debug Flits and control the number of Flits and debug content for targeted diagnostic purposes.

The transmission of NOP.Debug Flits operates on a best-effort basis, with no guarantee of delivery. The receiver has no requirements on how to handle the received Flits, but receiving NOP.Debug Flits must not affect the link state. This approach is designed to minimize the impact on the primary function of the PCI Express Link while still providing a channel for essential debug information. NOP.Debug and NOP.Vendor Flits are not replayed and are thus subject to loss due to bit errors. Further, transmission of NOP.Debug and NOP. Vendor Flits are not to interfere with entry and exit conditions for power management substates. Upon transition to a new state, transmission of NOP.Debug and NOP.Vendor Flits must be appropriately suspended or modified to align with the activity level permitted by the target state.

Table 1 below shows three NOP Flit type definitions along with their intended usages. All types defined below are considered NOP Flits and must follow all NOP Flit rules outlined in the PCIe specification. The NOP Flit types defined may rely on information provided by upper layers, but the transmission is done solely by the Physical Layer independently of the upper layers. Transmission may begin as soon as the Link enters L0. For NOP.Empty and NOP.Debug Flits, no credit checks are required for transmission. For NOP.Vendor Flits, implementation of any credit mechanism and associated checking for the credits is implementation specific (e.g., as defined by a corresponding vendor). A receiver that comprehends non-zero NOP Flit Type encodings must silently drop any NOP.Debug or NOP.Vendor Flits if it does not support processing them. . . . Receiver behavior for designs that do support processing NOP.Debug or NOP.Vendor Flits is implementation specific but transmitting/receiving NOP.Debug and NOP. Vendor Flits must not affect the link state.

TABLE 1
Example NOP Flit Types

| NOP Flit Type | Usage |
|---|---|
| NOP.Empty | Empty payload |
| NOP.Debug | Deliver debug information |
| NOP.Vendor | Deliver vendor-defined information |

A non-empty NOP Flit is a NOP Flit with a non-zero NOP Flit Type encoding. A NOP Stream is a sequence of NOP Flits that are sourced by a Transmitter. The NOP Stream ID field in the NOP Flit provides a mechanism to identify the original Transmitter of the NOP Flit. An NOP Flit Extended Capability structure may be defined and implemented to provide software control (e.g., via the NOP Stream ID Start and Number of NOP Streams fields) over the range of NOP Stream ID values that a Transmitter may use. The usage details of the programmed range may be implementation specific. The combination of NOP Flit Type value and NOP Stream ID value uniquely identifies a NOP Stream and its value must be unique across all entities transmitting NOP Flits over a given Link. NOP.Empty Flits may be defined to always transmit a NOP Stream ID value of 00h.

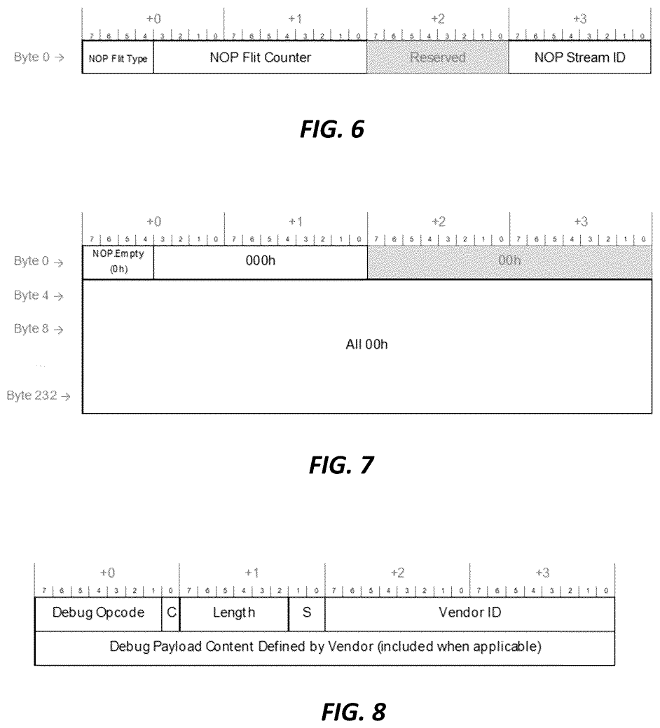

As shown in FIG. 6, a NOP Common Flit Header may be defined. The header may include a NPO Flit Counter field may be provided in the NOP Flit to allow dropped or missing non-empty NOP Flits to be detected. In one implementations, every NOP Stream has an independent counter, and each NOP Stream starts with a NOP Flit Counter value of 000h and every subsequent non-empty NOP Flit of the NOP Stream that is transmitted increments the stream's corresponding counter by one. The NOP Flit Counter may roll-over after FFEh, with a NOP Flit Counter value of FFFh indicating that an error or unexpected behavior occurred. This provides an indication that an unknown number of Flits of a NOP Stream were lost. This indication is only a hint since the Flit containing this indication could itself be lost. When a NOP Stream is disabled, its NOP Flit Counter is reset to 000h. NOP.Empty Flits may be configured to always transmit a NOP Flit Counter value of 000h. In some cases, Receivers may forward received NOP Flits with a NOP Stream ID other than FFh to a different Link. In this scenario, the forwarded NOP Flit is to preserve all fields as received, including a NOP Flit Type field, the NOP Flit Counter and the NOP Stream ID. The forwarding Receiver is permitted to overwrite the NOP Flit Counter to FFFh in certain situations. The forwarding mechanism is implementation specific on a best-effort basis, with no guarantee of delivery. After the first DW, the remaining TLP Bytes carry the NOP Flit Payload, whose definition varies depending on the NOP Flit Type. Table 2 describes common header fields in an example NOP flit format.

TABLE 2
Example NOP Flit Common Header

| Field | Location | Definition |
|---|---|---|
| NOP Flit | Byte 0: | 0h NOP.Empty Flit |
| Type | Bits 7:4 | 1h NOP.Debug Flit |
| | | 2h to Eh Reserved. Receiver must treat as a NOP.Empty Flit |
| | | Fh NOP.Vendor Flit |
| NOP Flit | {Byte 0: Bits | NOP.Empty Flit: Transmitter populates with 000h, Receiver |
| Counter | 3:0, Byte 1: | is permitted to ignore |
| | Bits 7:0} | NOP.Debug Flit and NOP.Vendor Flit: Incrementing per-NOP Flit |
| | | Type counter of NOP.Debug and NOP.Vendor Flit types |
| Reserved | Byte 2: Bits | Reserved |
| | 7:0 | |
| NOP | Byte 3: Bits | NOP.Empty Flit: Transmitter populates with 00h, Receiver |
| Stream ID | 7:0 | is permitted to ignore |
| | | NOP.Debug Flit and NOP.Vendor Flit: Original source identifier of |
| | | the NOP Flit |

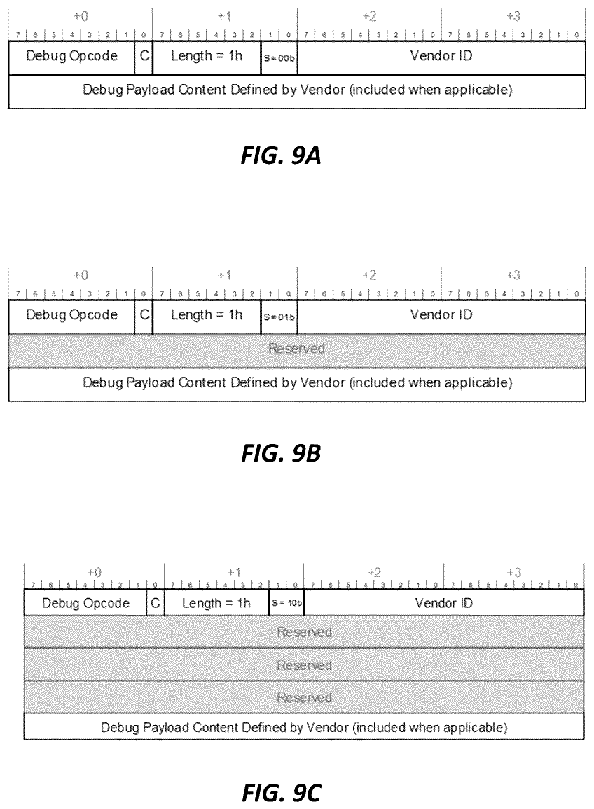

FIG. 7 is an example payload of an example NOP empty flit. A NOP.Empty Flit has an empty NOP Flit Payload with all bytes set to 00h. A NOP.Debug Flit uses one or more Debug Chunks to deliver vendor-defined link debug information. FIG. 8 shows an example debug chunk. Table 3 shows example definitions for fields of an example debug chunk. FIG. 9A shows an example Debug Chunk with one DW Debug Header and one DW Debug Payload, FIG. 9B shows an example Debug Chunk with two DW Debug Header Size and one DW Debug Payload, and FIG. 9C shows an example Debug Chunk with four DW Debug Header Size and one DW Debug Payload.

TABLE 3
Example NOP Debug Flit Fields

| Field | Location | Definition |
|---|---|---|
| Debug Opcode | Byte 0: | Debug opcode encoding defined by vendor that describes the |
| | Bits 7:1 | debug content. |
| Continuation (C) | Byte 0: | Indication this Debug Chunk is a continuation from the |
| | Bit 0 | previous Debug Chunk. This is only valid for the first Debug |
| | | Chunk of a Flit and must be Reserved otherwise. |
| | | Continuation chunks must have the same Debug Opcode and |
| | | Vendor ID as the previous chunk. |
| Length | Byte 1: | Length of the Debug Payload of the current Debug Chunk in |
| | Bits 7:2 | DW. The length cannot exceed the remaining number of DW |
| | | in the 236B TLP Bytes of the Flit. The maximum Length |
| | | value is 57 (1 DW NOP Flit Common Header + 1 DW Debug |
| | | Header + 57 DW Debug Payload = 236 Bytes of NOP Flit |
| | | Payload). A Length value of 0 indicates this Debug Chunk |
| | | only contains a Debug Header. |
| Debug Header | Byte 1: | Total size of the Debug Header in DW. Any additional bits |
| Size (S) | Bits 1:0 | beyond the first DW of the Debug Header are Reserved. |
| | | 00b One DW |
| | | 01b Two DW |
| | | 10b Four DW |
| | | 11b Reserved. Receiver must treat any NOP.Debug Flits |
| | | with this encoding as a NOP.Empty Flit. |
| | | Receivers that support NOP.Debug Flits must handle all valid |
| | | Debug Header Sizes. |
| Vendor ID | {Byte 2: | Vendor ID associated with the vendor that defined the Debug |
| | Bits 7:0, | Opcode |
| | Byte 3: | For PCI-SIG defined Debug Opcodes, this field must use the |
| | Bits 7:0} | PCI-SIG Vendor ID (0001h) |

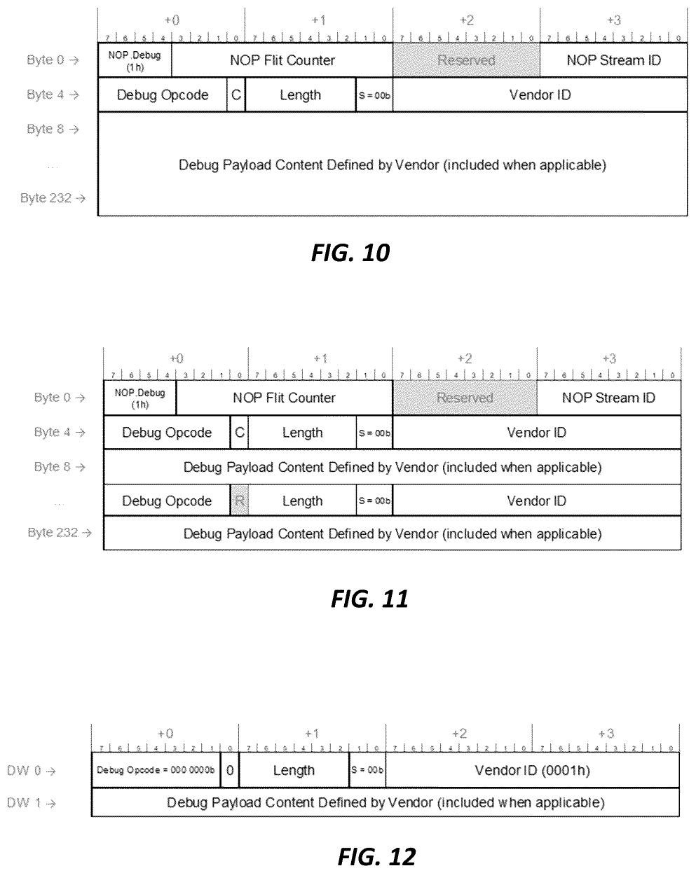

A NOP.Debug Flit uses one or more Debug Chunks to deliver vendor-defined link debug information. FIG. 10 shows an example NOP.Debug Flit with a single Debug Chunk. If multiple Debug Chunks are inserted into a Flit, subsequent Debug Chunk headers must begin immediately on the first available DW slot and set the Continuation bit to 0. It is permissible for Debug Chunks with different Vendor IDs to be inserted into a single Flit. FIG. 11 shows a NOP.Debug Flit with multiple Debug Chunks. Any unused DW slots at the end of the NOP Flit Payload of a NOP.Debug Flit must be filled with Empty Debug Chunks or set to 0. Table 4 shows example Debug Opcode values. An Empty Debug Chunk may be used for padding and alignment. This Debug Chunk does not contain any meaningful debug information and any Debug Payload content present must be ignored by receivers. The Continuation bit must be 0. The Debug Header Size field must be 00b. Receivers must silently drop any Empty Debug Chunk, where these values are not as stated. FIG. 12 shows an example Empty Debug Chunk.

FIG. 4: Example Debug Opcodes

| Debug | | |
|---|---|---|
| Opcode | Name | Description |
| 000 | Empty | Padding and alignment, containing no valid debug |
| 0000b | | information |
| 000 | Start Capture Trigger | Generic indication to start trace capture |
| 0001b | | |
| 000 | Stop Capture Trigger | Generic indication to stop trace capture |
| 0010b | | |
| 000 | FC Information Tracked | Flow Control information tracked by TX for TLP |
| 0011b | by Transmitter | Transmission gating |
| 000 | FC Information Tracked | Flow Control information tracked by RX for TLP |
| 0100b | by Receiver | Receiver accounting |
| 000 | Flit Mode Transmitter | Transmitter Flag and Counter values used for Flit |
| 0101b | Retry Flags and | Sequence Number and retry mechanism in Flit Mode |
| | Counters | |
| 000 | Flit Mode Receiver | Receiver Flag and Counter values used for Flit |
| 0110b | Retry Flags and | Sequence Number and retry mechanism in Flit Mode |
| | Counters | |
| 000 | Buffer Occupancy | Current Occupancy of the reported structure |
| 0111b | | |
| 000 | Link Debug Request | Request for link partner to return a NOP.Debug Flit |
| 1000b | | with a specified Debug Opcode |

All other encodings are Reserved

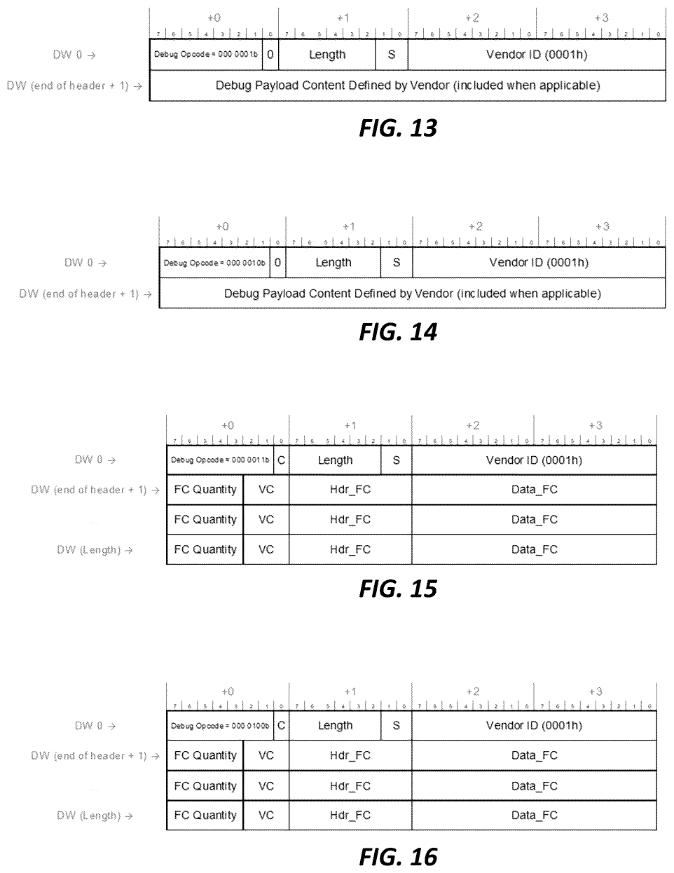

In some implementations, such as shown in FIG. 13, a Start Capture Trigger Debug Chunk may be defined and used to indicate to debug tools such as Logic Analyzers to start capturing what follows the NOP.Debug Flit on the Link. No Debug Payload is required for this Debug Chunk, but a transmitter may choose to insert vendor-defined content. The Continuation bit must be 0. Receivers are permitted to silently drop any Start Capture Trigger Debug Chunk, where this value is not as stated. For ease of use by debug tools, this may only be inserted into the first Debug Chunk of the NOP Flit. Likewise, in some implementations, such as shown in FIG. 14, a Stop Capture Trigger Debug Chunk may be defined and used to indicate to debug tools such as Logic Analyzers to stop capturing what follows the NOP.Debug Flit on the Link. No Debug Payload is required for the Stop Capture Trigger Debug Chunk but a transmitter may choose to insert vendor-defined content. The Continuation bit must be 0. Receivers are permitted to silently drop any Stop Capture Trigger Debug Chunk, where this value is not as stated. For ease of use by debug tools, this may only be inserted into the first Debug Chunk of the NOP Flit.

Flow control (FC) Information may be tracked by transmitter and a corresponding Debug Chunk defined (such as shown in the example of FIG. 15) to transmit the information tracked by a Transmitter for Flow Control TLP Transmission gating. For instance, after the Debug Header, each DW of Debug Payload may include a FC Quantity field to indicate the FC quantity information being sent in the remainder of the DW, which contains VC and Header/Data credit values. The Port must only transmit FC quantity information for VCs that it supports. FIG. 15 shows a Debug Chunk with multiple FC quantities inserted. Table 5 includes various FC Quantity field encodings. The VC field contains the VC number, the Hdr_FC field contains the Header credits for the FC Quantity for that VC, and the Data_FC field contains the Data credits for the FC Quantity for the VC. Further, a FC Information Tracked by Receiver Debug Chunk may be defined for use in transmitting the information tracked by a Receiver for Flow Control TLP Receiver accounting. After the Debug Header, each DW of Debug Payload consists of a FC Quantity field to indicate the FC quantity information being sent in the remainder of the DW, which contains VC and Header/Data credit values. The Port must only transmit FC quantity information for VCs that it supports. FIG. 16 shows such a Debug Chunk with multiple FC quantities inserted. Table 6 shows example FC Quantity field encodings for the receiver side. The VC field contains the VC number, the Hdr_FC field contains the Header credits for the FC Quantity for that VC, and the Data_FC field contains the Data credits for the FC Quantity for the VC.

TABLE 5
Example FC Information Tracked by Transmitter Encodings

| FC Quantity | |
|---|---|
| Encoding | FC Quantity |
| 0 0000b | No valid info |
| 0 0001b | Credit_Consumed_P |
| 0 0010b | Credit_Consumed_NP |
| 0 0011b | Credit_Consumed_CPL |
| 0 0100b | Shared_Credit_Consumed_P |
| 0 0101b | Shared_Credit_Consumed_NP |
| 0 0110b | Shared_Credit_Consumed_CPL |
| 0 0111b | Shared_Credit_Consumed_Currently_P |
| 0 1000b | Shared_Credit_Consumed_Currently_NP |
| 0 1001b | Shared_Credit_Consumed_Currently_CPL |
| 0 1010b | Credit_Limit_P |
| 0 1011b | Credit_Limit_NP |
| 0 1100b | Credit_Limit_CPL |
| 0 1101b | Shared_Credit_Limit_P |
| 0 1110b | Shared_Credit_Limit_NP |
| 0 1111b | Shared_Credit_Limit_CPL |
| 1 0000b | Sum_Shared_Credit_Consumed_P |
| 1 0001b | Sum_Shared_Credit_Consumed_NP |
| 1 0010b | Sum_Shared_Credit_Consumed_CPL |
| 1 0011b | Total_Shared_Credit_Available_P |
| 1 0100b | Total_Shared_Credit_Available_NP |
| 1 0101b | Total_Shared_Credit_Available_CPL |
| 1 0110b | Sum_Shared_Credit_Limit_P |
| 1 0111b | Sum_Shared_Credit_Limit_NP |
| 1 1000b | Sum_Shared_Credit_Limit_CPL |
| 1 1001b | SHARED_CUMULATIVE_CREDITS_REQUIRED_P |
| 1 1010b | SHARED_CUMULATIVE_CREDITS_REQUIRED_NP |
| 1 1011b | SHARED_CUMULATIVE_CREDITS_REQUIRED_{—} |
| | CPL |
| 1 1100b | CUMULATIVE_CREDITS_REQUIRED_P |
| 1 1101b | CUMULATIVE_CREDITS_REQUIRED_NP |
| 1 1110b | CUMULATIVE_CREDITS_REQUIRED_CPL |
| 1 1111b | Reserved |

TABLE 6
Example FC Information Tracked by Receiver Encodings

| FC Quantity Encoding | FC Quantity |
|---|---|
| 0 0000b | No valid info |
| 0 0001b | Credits_Allocated_P |
| 0 0010b | Credits_Allocated_NP |
| 0 0011b | Credits_Allocated_CPL |
| 0 0100b | Shared_Credits_Allocated_P |
| 0 0101b | Shared_Credits_Allocated_NP |
| 0 0110b | Shared_Credits_Allocated_CPL |
| 0 0111b | Credits_Received_P |
| 0 1000b | Credits_Received_NP |
| 0 1001b | Credits_Received_CPL |
| 0 1010b | Shared_Credits_Received_P |
| 0 1011b | Shared_Credits_Received_NP |
| 0 1100b | Shared_Credits_Received_CPL |
| | All other encodings are Reserved |

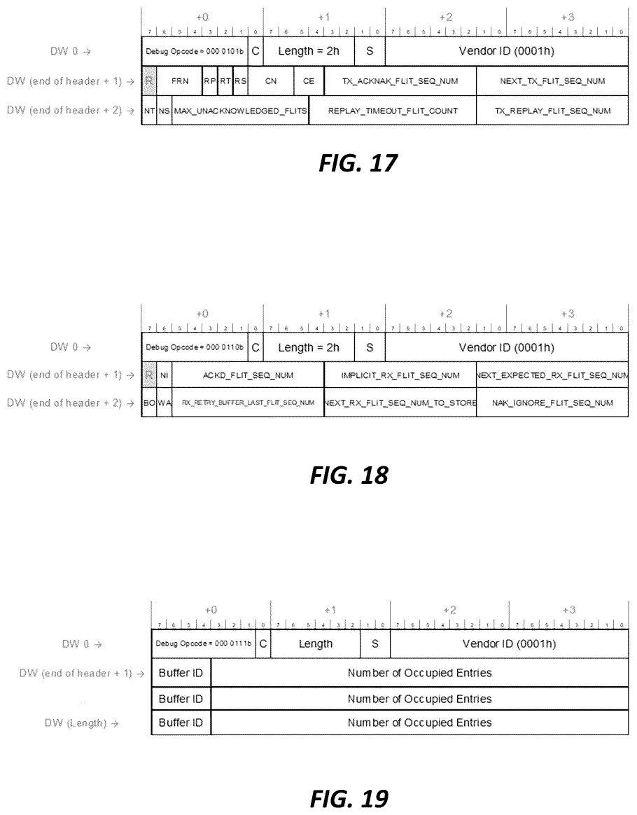

In some implementations, a Flit Mode Transmitter Retry Flags and Counters Debug Chunk may be defined, such as shown in the example of FIG. 17, to transmit the transmitter flag and counter values for Flit Sequence Number and retry tracking for Flit Mode. The Length field must be 2h. Receivers are permitted to silently drop any Flit Mode Transmitter Retry Flags and Counters Debug Chunk, where this value is not as stated. Table 7 includes a description of the fields within the Debug Payload. Similarly, a Flit Mode Receiver Retry Flags and Counters Debug Chunk may be defined (such as shown in FIG. 18, to transmit the receiver flag and counter values for Flit Sequence Number and retry tracking for Flit Mode. The Length field must be 2h. Receivers are permitted to silently drop any Flit Mode Receiver Retry Flags and Counters Debug Chunk, where this value is not as stated. Table 8 includes descriptions of the corresponding fields within the Debug Payload.

TABLE 7
Flit Mode Transmitter Retry Flags and Counter Fields

| Field | Location |
|---|---|
| Reserved | Byte 4: Bit 7 |
| FLIT_REPLAY_NUM (FRN) | Byte 4: Bits 6:4 |
| REPLAY_IN_PROGRESS (RP) | Byte 4: Bit 3 |
| REPLAY_SCHEDULED_TYPE (RT) | Byte 4: Bit 2 |
| REPLAY_SCHEDULED (RS) | Byte 4: Bit 1 |
| CONSECUTIVE_TX_NAK_FLITS (CN) | {Byte 4: Bit 0, Byte 5: Bits 7:6} |
| CONSECUTIVE_TX_EXPLICIT_SEQ_NUM_FLITS (CE) | Byte 5: Bits 5:4 |
| TX_ACKNAK_FLIT_SEQ_NUM | {Byte 5: Bits 3:0, Byte 6: Bits 7:2} |
| NEXT_TX_FLIT_SEQ_NUM | {Byte 6: Bits 1:0, Byte 7: Bits 7:0} |
| NAK_SCHEDULED_TYPE (NT) | Byte 8: Bit 7 |
| NAK_SCHEDULED (NS) | Byte 8: Bit 6 |
| MAX_UNACKNOWLEDGED_FLITS | {Byte 8: Bits 5:0, Byte 9: Bits 7:5} |
| REPLAY_TIMEOUT_FLIT_COUNT | {Byte 9: Bits 4:0, Byte 10: Bits 7:2} |
| TX_REPLAY_FLIT_SEQ_NUM | {Byte 10: Bits 1:0, Byte 11: Bits 7:0} |

TABLE 8
Flit Mode Receiver Retry Flags and Counter Fields

| Field | Location |
|---|---|
| Reserved | Byte 4: Bit 7 |
| NON_IDLE_EXPLICIT_SEQ_NUM_FLIT_RCVD (NI) | Byte 4: Bit 6 |
| ACKD_FLIT_SEQ_NUM | {Byte 4: Bits 5:0, Byte 5: Bits 7:4} |
| IMPLICIT_RX_FLIT_SEQ_NUM | {Byte 5: Bits 3:0, Byte 6: Bits 7:2} |
| NEXT_EXPECTED_RX_FLIT_SEQ_NUM | {Byte 6: Bits 1:0, Byte 7: Bits 7:0} |
| RX_RETRY_BUFFER_OVERFLOW (BO) | Byte 8: Bit 7 |
| NAK_WITHDRAWAL_ALLOWED (WA) | Byte 8: Bit 6 |
| RX_RETRY_BUFFER_LAST_FLIT_SEQ_NUM | {Byte 8: Bits 5:0, Byte 9: Bits 7:4} |
| NEXT_RX_FLIT_SEQ_NUM_TO_STORE | {Byte 9: Bits 3:0, Byte 10: Bits 7:2} |
| NAK_IGNORE_FLIT_SEQ_NUM | {Byte 10: Bits 1:0, Byte 11: Bits 7:0} |

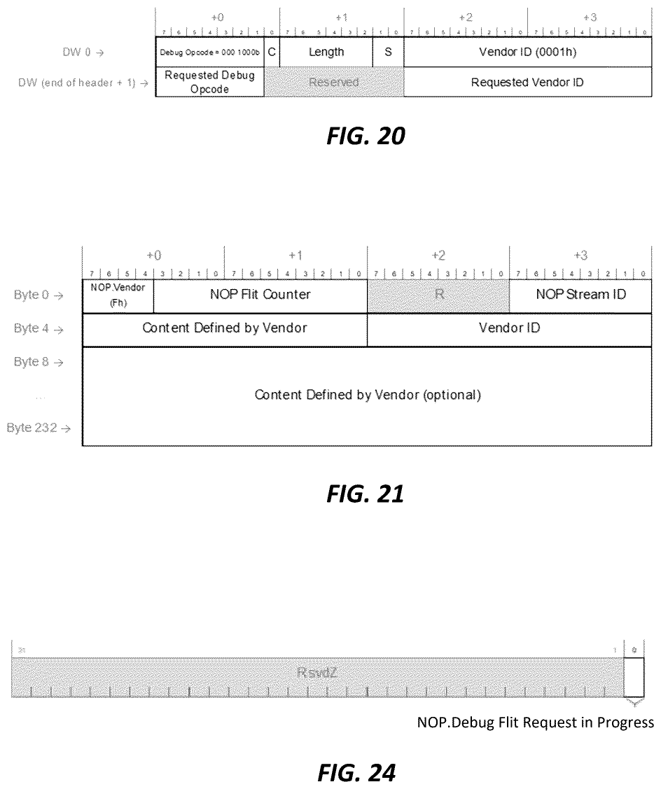

In some implementations, a Buffer Occupancy Debug Chunk may be defined, such as shown in FIG. 19, to transmit the current occupancy of the reported structure. After the Debug Header, each DW of Debug Payload consists of a Buffer ID field to indicate the buffer structure being sent in the remainder of the DW, which contains Number of Occupied Entries values. FIG. 19 shows a Debug Chunk with multiple buffers inserted. Table 9 shows example Buffer ID field encodings. The Number of Occupied Entries field contains the current occupancy value for the Buffer ID. The Link Debug Request Debug Chunk, such as shown in FIG. 20, is used to transmit a request for the Receiver to return a NOP.Debug Flit with the requested Debug Opcode. After the Debug Header, a single DW of Debug Payload is used to indicate the Requested Debug Opcode and the associated Vendor ID. For ease of use by the Receiver, this may only be inserted into the first chunk of the NOP Flit. Receiver responds on a best effort basis, and is permitted to ignore the request if it cannot service it.

TABLE 9
Buffer Occupancy Encodings

| Buffer ID Encoding | Buffer ID |
|---|---|
| 0h | TX Retry Buffer |
| 1h | RX Retry Buffer |
| | All other encodings are Reserved |

Turning to FIG. 21, an example NOP. Vendor Flit is illustrated, which may serves as a general purpose type flit that can be utilized by a vendor to transmit proprietary information. After the NOP Flit Common Header, the next DW contains a Vendor ID field that identifies the vendor associated with this Flit, and all other bytes in the Flit are available for vendor usage. It is recommended for vendors to include a sub-type field.

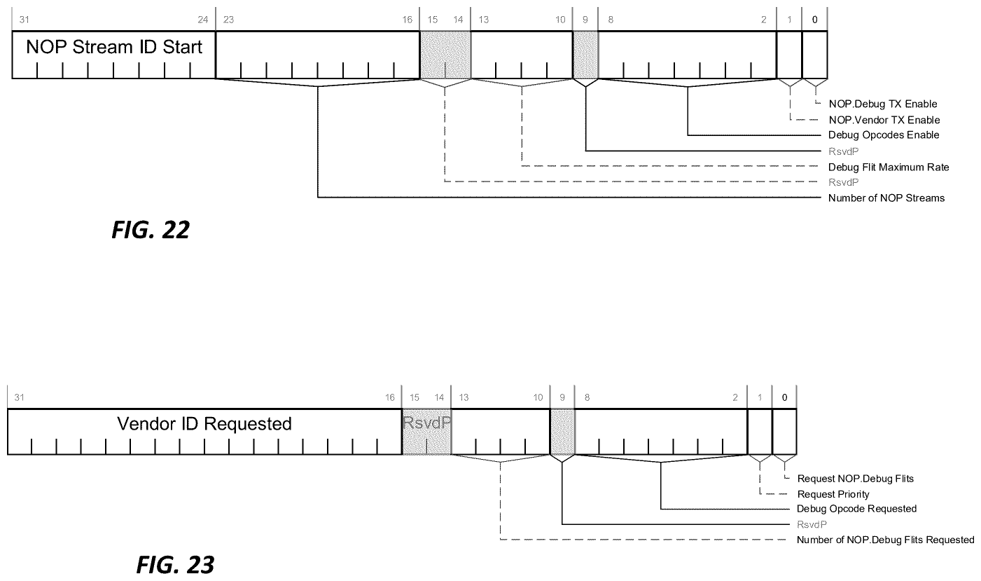

Registers may be provided in connection with NOP flits used for a link. For instance. FIG. 22 shows a NOP Flit Control 1 Register (Offset 08h). FIG. 22 shows the allocation of register fields in the NOP Flit Control 1 Register. Table 10 provides respective bit definitions for the register.

TABLE 10
NOP Flit Control 1 Register Fields

| Bit | | |
|---|---|---|
| Location | Register Description | Attr. |
| 0 | NOP.Debug TX Enable - When Set, this bit enables capable transmitters of | RWS/ |
| | sending NOP.Debug Flits. When Clear, the transmitter must not send any | RsvdP |
| | NOP.Debug Flits. | |
| | This bit is RsvdP when the NOP.Debug TX Support bit is Clear. | |
| | Default value of this bit is implementation specific. | |
| 1 | NOP.Vendor TX Enable - When Set, this bit enables capable transmitters of | RWS/ |
| | sending NOP.Vendor Flits. When Clear, the transmitter must not send any | RsvdP |
| | NOP.Vendor Flits. | |
| | This bit is RsvdP when the NOP.Vendor TX Support bit is Clear. | |
| | Default value of this bit is implementation specific. | |
| 8:2 | Debug Opcodes Enable - When the NOP.Debug TX Enable bit is Set, this field | RWS/ |
| | controls which PCI-SIG defined Debug Opcodes may be sent by the transmitter. | RsvdP |
| | If this field is Zero, the transmitter may send any PCI-SIG defined Debug | |
| | Opcode; otherwise, the transmitter may only send the PCI-SIG defined Debug | |
| | Opcode encoding programmed into this field. Control over non-PCI-SIG defined | |
| | Debug Opcodes is vendor specific. | |
| | This bit is RsvdP when the NOP.Debug TX Support bit is Clear. | |
| | Default value of this field is Zero. | |
| 13:10 | Debug Flit Maximum Rate Hint - Controls the desired maximum rate of | RWS/ |
| | NOP.Debug Flit injection by the transmitter for periodic Debug Opcodes not | RsvdP |
| | triggered by hardware events. Non-periodic NOP.Debug Flits that are triggered | |
| | by hardware events are not limited by this setting and may be scheduled | |
| | independently. A transmitter is permitted to inject at a lower or higher rate | |
| | than the maximum rate in this field. | |
| | Defined encodings are: | |
| | 0h Link rate (one every Flit) | |
| | 1h Link rate/2 (one every two Flits) | |
| | 2h Link rate/3 (one every three Flits) | |
| | 3h Link rate/4 (one every four Flits) | |
| | 4h Link rate/5 (one every five Flits) | |
| | 5h Link rate/6 (one every six Flits) | |
| | 6h Link rate/7 (one every seven Flits) | |
| | 7h Link rate/8 (one every eight Flits) | |
| | 8h Link rate/9 (one every nine Flits) | |
| | 9h Link rate/10 (one every ten Flits) | |
| | All other encodings are Reserved. | |
| | This field is RsvdP when the NOP.Debug TX Support bit is Clear. | |
| | Default value of this field is 3h. | |
| 23:16 | Number of NOP Streams - When either or both the NOP.Debug TX Enable bit | RWS/ |
| | or the NOP.Vendor TX Enable bit are Set, this field controls the number of NOP | RsvdP |
| | Stream IDs the Transmitter may use for sending NOP Flits. The field's value is | |
| | the total number of NOP Streams minus one. A value of 0 indicates support for | |
| | one NOP Stream. | |
| | The upper end NOP Stream ID value is defined as NOP Stream ID Start + | |
| | Number of NOP Streams, with an upper limit of FFh. For example, if the | |
| | Number of NOP Streams field contains 5h and the NOP Stream ID Start field | |
| | contains FEh, the range of Transmitter usable NOP Stream IDs would only be | |
| | FEh and FFh (i.e., two NOP Stream IDs), even though the Number of NOP | |
| | Streams field value was programmed to be greater than that. | |
| | This field is only used when originating NOP Flits and has no effect on | |
| | forwarding NOP Flits between Ports. | |
| | This field is RsvdP when the NOP.Vendor TX Support and the NOP.Debug TX | |
| | Support bits are both Clear. | |
| | Default value of this field is 0. | |
| 31:24 | NOP Stream ID Start - When either or both the NOP.Debug TX Enable bit or | RWS/ |
| | the NOP.Vendor TX Enable bit are Set, this field controls the lower end of the | RsvdP |
| | range of NOP Stream IDs that the Transmitter may use for sending NOP Flits. | |
| | This field is only used when originating NOP Flits and has no effect on | |
| | forwarding NOP Flits between Ports. | |
| | This field is RsvdP when the NOP.Vendor TX Support and the NOP.Debug TX | |
| | Support bits are both Clear. | |
| | Default value of this field is FFh. | |

FIG. 23 shows a NOP Flit Control 2 Register (Offset 0Ch). FIG. 23 shows the allocation of register fields in the NOP Flit Control 2 Register. Table 11 provides the respective bit definitions for the register.

TABLE 11
NOP Flit Control 2 Register Fields

| Bit | | |
|---|---|---|
| Location | Register Description | Attr. |
| 0 | Request NOP.Debug Flits -When NOP.Debug TX Enable is Set, this bit requests | RW/ |
| | NOP.Debug Flits to be initiated by a transmitter. A write of 1b to this bit | RsvdP |
| | initiates the request so that the transmitter samples the Request Priority, the | (see |
| | Debug Opcode Requested, the Number of NOP.Debug Flits Requested, and the | description) |
| | Vendor ID Requested fields and attempts to fulfill the request on a best effort | |
| | basis. | |
| | It is permitted to write 1b to this bit while simultaneously writing modified | |
| | values to other fields in this register. The resulting request must use the | |
| | modified values. | |
| | Hardware behavior is undefined if this is written while the NOP.Debug Flit | |
| | Request in Progress bit is Set. | |
| | This bit will always return 0b when read. | |
| | This bit is RsvdP when NOP.Debug TX Support is Clear. | |
| | Default value of this bit is Zero. | |
| 1 | Request Priority - When the NOP.Debug TX Enable bit is Set, this bit controls | RW/ |
| | the priority of the requested NOP.Debug Flits. If this bit is Set, the transmitter | RsvdP |
| | must prioritize the requested NOP.Debug Flits over any periodic NOP.Debug | |
| | Flit transmissions. If this bit is Clear, the transmitter need not prioritize the | |
| | requested NOP.Debug Flits over any periodic NOP.Debug Flit transmissions. | |
| | This bit is RsvdP when NOP.Debug TX Support is Clear. | |
| | Default value of this bit is Zero. | |
| 8:2 | Debug Opcode Requested - When the NOP.Debug TX Enable bit is Set, this | RW/ |
| | field controls which Debug Opcode is requested for transmission. | RsvdP |
| | This field is RsvdP when the NOP.Debug TX Support bit is Clear. | |
| | Default value of this field is Zero. | |
| 13:10 | Number of NOP.Debug Flits Requested - When the NOP.Debug TX Enable bit is | RW/ |
| | Set, this field controls the number of NOP.Debug Flits requested for | RsvdP |
| | transmission. | |
| | This bit is RsvdP when the NOP.Debug TX Support bit is Clear. | |
| | Default value of this field is Zero. | |
| 31:16 | Vendor ID Requested - When the NOP.Debug TX Enable bit is Set, this field | RW/ |
| | controls which Vendor ID associated with the Debug Opcode is requested for | RsvdP |
| | transmission. | |
| | This field is RsvdP when the NOP.Debug TX Support bit is Clear. | |
| | Default value of this field is 0. | |

FIG. 24 shows allocation of register fields in a NOP Flit Status Register (Offset 10h). Table 12 provides the respective bit definitions for the status register.

TABLE 12
NOP Flit Status Register Fields

| Bit | | |
|---|---|---|
| Location | Register Description | Attr. |
| 0 | NOP.Debug Flit Request in Progress - When Set, this bit indicates that the | RO/ |
| | Transmitter has started to fulfill the requested NOP.Debug Flits and that the | RsvdZ |
| | request has not yet been fully completed. A Transmitter reports this bit Clear | |
| | only when the request has been fully completed or the request has been | |
| | cancelled. This bit must also be Cleared when the NOP.Debug TX Enable bit is | |
| | Cleared. | |
| | Ports that do not implement the ability to transmit the requested NOP.Debug | |
| | Flits are permitted to hardwire this bit to 0b. | |
| | This bit is RsvdZ when the NOP.Debug TX Support bit is Clear. | |
| | Default value of this bit is 0. | |

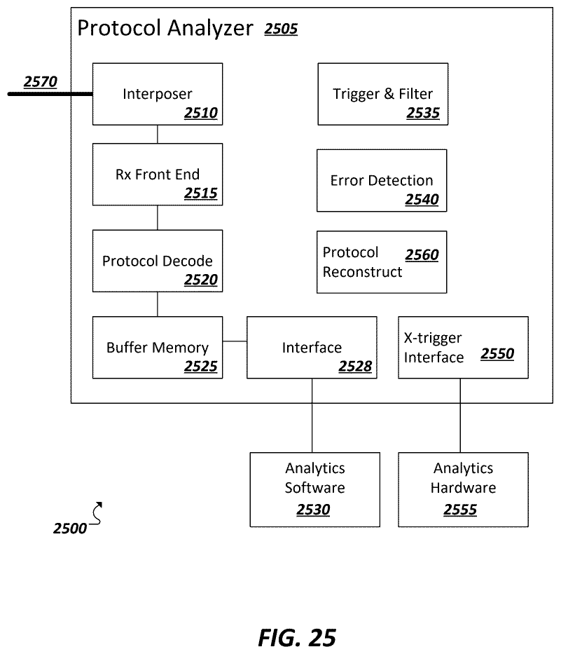

In some implementations, one or more debug tools or circuits may be provided in a system and may consume debug information communicated in an example NOP debug flit (e.g., NOP.Debug). As an example, a debug tool may be implemented as a dedicated PCIe protocol analyzer or other protocol analyzer tool. For instance, FIG. 25 is a simplified block diagram 2500 of an example protocol analyzer 2505. The protocol analyzer 2505 may include a probe or interposer (e.g., 2510) configured to provide a non-intrusive electrical connection to a PCIe link 2570 (e.g., a link under test). The probe or interposer 2510 may be disposed on a link between two devices (e.g., between a root complex and an endpoint device) such that PCIe traffic passes transparently through the interposer 2510 while electrical signals are concurrently captured for analysis. For instance, packets and flits (including NOP flits) may be communicated on the link and intercepted by the interposer 2510. The interposer 2510 may further include one or more retimers, redrivers, or equalization circuits to compensate for insertion loss, and may be implemented in various form factors including slot-based adapters, M.2, U.2, or cabled connectors, among other examples. Signals captured by the interposer or probe (e.g., 2510) may be supplied to a high-speed receiver front-end 2515 of the protocol analyzer 2505. The receiver front-end 2515 may include one or more serializer-deserializer (SerDes) circuits operable to recover and decode PCIe physical layer signaling (e.g., flits) across multiple generations of the standard. Further, equalization functions such as continuous-time linear equalization (CTLE), finite impulse response (FIR) filtering, and decision-feedback equalization (DFE) may be employed to compensate for channel degradation using the receiver front end 2515. The receiver front-end 2515 may further incorporate lane deskew logic and timestamping elements, among other example components, to align traffic received across bonded lanes and to preserve accurate temporal ordering of protocol events, among other example functionality.

Continuing with the example of FIG. 25, a symbol stream recovered using the receiver front end 2515 may be provided to a protocol decode engine 2520. In some implementations, the protocol decode engine 2520 may be implemented in a field programmable gate array (FPGA) or application-specific integrated circuit (ASIC) to permit real-time decoding of the data (e.g., at full line rate). The protocol decode engine 2520 may reconstruct ordered sets, training sequences, data link layer packets (DLLPs), and transaction layer packets (TLPs), and may further identify error conditions such as cyclic redundancy check (CRC) errors, replay events, or credit violations. In some embodiments, the protocol decode engine 2520 includes programmable trigger and filter logic to enable selective capture of PCIe traffic under defined conditions, such as entry into a link state, detection of a configuration transaction, or occurrence of a specific sequence of events, among other examples. Captured protocol information may be stored in a buffer memory (e.g., 2525) that may include one or more high-speed memory devices such as synchronous dynamic random-access memory (SDRAM) or graphics double data rate (GDDR) memory. The buffer memory 2525 may allow storage of extended traffic traces without packet loss. In some examples, the buffer memory 2525 may be segmented into multiple capture partitions, each of which may be armed or triggered independently such that multiple snapshots of traffic can be preserved. This arrangement allows an analyzer to record both pre-trigger and post-trigger conditions surrounding an event of interest. An interface 2528 may allow this event data to be accessed and consumed (e.g., over a PCIe, Ethernet, or Thunderbolt interface) by analytics software (e.g., 2530) executed on a host device. The analytics software 2530 may be configured to reconstruct protocol hierarchies, provide graphical visualization of captured transactions, perform compliance checking relative to PCI-SIG specifications, and permit filtering and searching of captured data. The software may additionally include scripting interfaces for automated regression testing, transaction-tracking functions that correlate requests with corresponding completions, and compliance-aware error highlighting functions that reference applicable specification clauses. In some implementations, functionality of the analytics software 2530 may be implemented in hardware circuitry logic, such as logic resident on the protocol analyzer tool 2505.

In some implementations, the protocol analyzer 2505 may include advanced trigger and filter hardware 2535 configured to perform complex conditional logic and may include examples such as state-machine-based trigger circuits that allow capture of link data based upon detection of specified sequences, or link state entries or exits. Multi-level filters may be included to further restrict capture to traffic involving particular addresses, opcodes, or functions, among other examples to filter irrelevant packets. In some example implementations, the protocol analyzer 2505 may include an error detection and correlation engine 2540 configured to monitor captured traffic for violations of protocol rules, including CRC mismatches, replay timer expirations, credit exhaustion, and other violations. Debug information in NOP debug flits may additionally communicate information concerning the higher protocol layers to allow errors in these layers to also be identified. Events detected by the error detection and correlation engine 2540 may be timestamped and cross-referenced to provide direct navigation to a point of failure within a trace file, among other example uses. For instance, the error detection and correlation engine 2540 may additionally reconstruct link training and state machine transitions to support debugging of link-level instability.

The protocol analyzer 2505, in some implementations, may also include one or more cross-trigger and synchronization interfaces 2550. Such interfaces may provide trigger-in and trigger-out ports enabling hardware-level synchronization with various analytics hardware 2555, such as oscilloscopes, other logic analyzers, power measurement instruments, or analyzers for other protocols. In some implementations, the protocol analyzer 2505 may include logic 2560 configured to perform real-time protocol reconstruction, such as through FPGA-based pipelines in the protocol analyzer 2505 that decode traffic and present decoded packets and link states to the analytics software 2530 with minimal latency. This capability allows a user to observe LTSSM transitions, link retraining sequences, and credit allocation conditions as they occur in the system under test. Indeed, an example PCIe protocol analyzer (e.g., 2505) may support not only a passive capture path for monitoring and capturing data on a PCIe link (e.g., including debug information included in debug chunks of NOP flits), but also circuitry to perform various debugging-oriented tasks, allowing users to isolate intermittent errors (including errors at the transaction layer and higher), correlate failures with cross-domain conditions, and efficiently identify root causes of interoperability or protocol-compliance problems in PCIe-based systems, among other example features.

While the examples above pertain to PCIe-based protocols, it should be appreciated that these examples are presented to illustrate more generalized principles and features, which may be applied to other interconnect protocols including Compute Express Link (CXL), NVLink, Universal Chiplet Interconnect Express (UCIe), Ultra Path Interconnect (UPI), Infinity Fabric, among other example protocols. Note further that the apparatus', methods', and systems described above may be implemented in any electronic device or system as aforementioned. As specific illustrations, the figures below provide exemplary systems for utilizing the concepts as described herein. As the systems below are described in more detail, a number of different interconnects are disclosed, described, and revisited from the discussion above. And as is readily apparent, the advances described above may be applied to any of those interconnects, fabrics, or architectures.

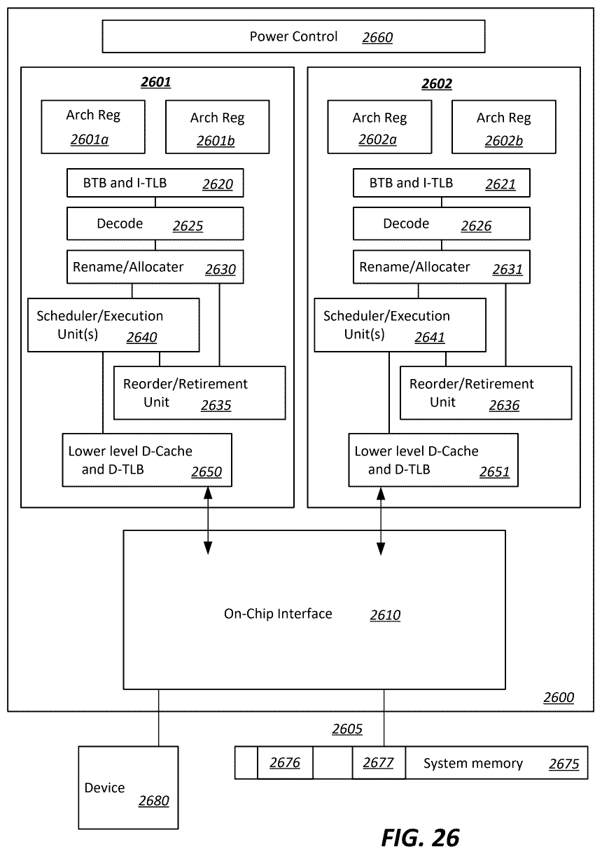

Referring to FIG. 26, an embodiment of a block diagram for a computing system including a multicore processor is depicted. Processor 2600 includes any processor or processing device, such as a microprocessor, an embedded processor, a digital signal processor (DSP), a network processor, a handheld processor, an application processor, a co-processor, a system on a chip (SOC), or other device to execute code. Processor 2600, in one embodiment, includes at least two cores-core 2601 and 2602, which may include asymmetric cores or symmetric cores (the illustrated embodiment). However, processor 2600 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 2600, as illustrated in FIG. 26, includes two cores-core 2601 and 2602. Here, core 2601 and 2602 are considered symmetric cores, i.e. cores with the same configurations, functional units, and/or logic. In another embodiment, core 2601 includes an out-of-order processor core, while core 2602 includes an in-order processor core. However, cores 2601 and 2602 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such as a binary translation, may be utilized to schedule or execute code on one or both cores. Yet to further the discussion, the functional units illustrated in core 2601 are described in further detail below, as the units in core 2602 operate in a similar manner in the depicted embodiment.

As depicted, core 2601 includes two hardware threads 2601a and 2601b, which may also be referred to as hardware thread slots 2601a and 2601b. Therefore, software entities, such as an operating system, in one embodiment potentially view processor 2600 as four separate processors, i.e., four logical processors or processing elements capable of executing four software threads concurrently. As alluded to above, a first thread is associated with architecture state registers 2601a, a second thread is associated with architecture state registers 2601b, a third thread may be associated with architecture state registers 2602a, and a fourth thread may be associated with architecture state registers 2602b. Here, each of the architecture state registers (e.g., 2601a, 2601b, 2602a, and 2602b) may be referred to as processing elements, thread slots, or thread units, as described above. As illustrated, architecture state registers 2601a are replicated in architecture state registers 2601b, so individual architecture states/contexts are capable of being stored for logical processor 2601a and logical processor 2601b. In core 2601, other smaller resources, such as instruction pointers and renaming logic in allocator and renamer block 2630 may also be replicated for threads 2601a and 2601b. Some resources, such as re-order buffers in reorder/retirement unit 2635, ILTB 2620, load/store buffers, and queues may be shared through partitioning. Other resources, such as general purpose internal registers, page-table base register(s), low-level data-cache and data-TLB 2615, execution unit(s) 2640, and portions of out-of-order unit 2635 are potentially fully shared.

Processor 2600 often includes other resources, which may be fully shared, shared through partitioning, or dedicated by/to processing elements. In FIG. 26, an embodiment of a purely exemplary processor with illustrative logical units/resources of a processor is illustrated. Note that a processor may include, or omit, any of these functional units, as well as include any other known functional units, logic, or firmware not depicted. As illustrated, core 2601 includes a simplified, representative out-of-order (OOO) processor core. But an in-order processor may be utilized in different embodiments. The OOO core includes a branch target buffer 2620 to predict branches to be executed/taken and an instruction-translation buffer (I-TLB) 2620 to store address translation entries for instructions.

Core 2601 further includes decode module 2625 coupled to fetch unit 2620 to decode fetched elements. Fetch logic, in one embodiment, includes individual sequencers associated with thread slots 2601a, 2601b, respectively. Usually core 2601 is associated with a first ISA, which defines/specifies instructions executable on processor 2600. Often machine code instructions that are part of the first ISA include a portion of the instruction (referred to as an opcode), which references/specifies an instruction or operation to be performed. Decode logic 2625 includes circuitry that recognizes these instructions from their opcodes and passes the decoded instructions on in the pipeline for processing as defined by the first ISA. For example, as discussed in more detail below decoders 2625, in one embodiment, include logic designed or adapted to recognize specific instructions, such as transactional instruction. As a result of the recognition by decoders 2625, the architecture or core 2601 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 2626, in one embodiment, recognize the same ISA (or a subset thereof). Alternatively, in a heterogeneous core environment, decoders 2626 recognize a second ISA (either a subset of the first ISA or a distinct ISA).

In one example, allocator and renamer block 2630 includes an allocator to reserve resources, such as register files to store instruction processing results. However, threads 2601a and 2601b are potentially capable of out-of-order execution, where allocator and renamer block 2630 also reserves other resources, such as reorder buffers to track instruction results. Unit 2630 may also include a register renamer to rename program/instruction reference registers to other registers internal to processor 2600. Reorder/retirement unit 2635 includes components, such as the reorder buffers mentioned above, load buffers, and store buffers, to support out-of-order execution and later in-order retirement of instructions executed out-of-order.

Scheduler and execution unit(s) block 2640, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 2650 are coupled to execution unit(s) 2640. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 2601 and 2602 share access to higher-level or further-out cache, such as a second level cache associated with on-chip interface 2610. Note that higher-level or further-out refers to cache levels increasing or getting further way from the execution unit(s). In one embodiment, higher-level cache is a last-level data cache—last cache in the memory hierarchy on processor 2600—such as a second or third level data cache. However, higher level cache is not so limited, as it may be associated with or include an instruction cache. A trace cache—a type of instruction cache-instead may be coupled after decoder 2625 to store recently decoded traces. Here, an instruction potentially refers to a macro-instruction (i.e. a general instruction recognized by the decoders), which may decode into a number of micro-instructions (micro-operations).

In the depicted configuration, processor 2600 also includes on-chip interface module 2610. Historically, a memory controller, which is described in more detail below, has been included in a computing system external to processor 2600. In this scenario, on-chip interface 2610 is to communicate with devices external to processor 2600, such as system memory 2675, a chipset (often including a memory controller hub to connect to memory 2675 and an I/O controller hub to connect peripheral devices), a memory controller hub, a northbridge, or other integrated circuit. And in this scenario, bus 2605 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 2675 may be dedicated to processor 2600 or shared with other devices in a system. Common examples of types of memory 2675 include DRAM, SRAM, non-volatile memory (NV memory), and other known storage devices. Note that device 2680 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 2600. For example, in one embodiment, a memory controller hub is on the same package and/or die with processor 2600. Here, a portion of the core (an on-core portion) 2610 includes one or more controller(s) for interfacing with other devices such as memory 2675 or a graphics device 2680. The configuration including an interconnect and controllers for interfacing with such devices is often referred to as an on-core (or un-core configuration). As an example, on-chip interface 2610 includes a ring interconnect for on-chip communication and a high-speed serial point-to-point link 2605 for off-chip communication. Yet, in the SOC environment, even more devices, such as the network interface, co-processors, memory 2675, graphics processor 2680, and any other known computer devices/interface may be integrated on a single die or integrated circuit to provide small form factor with high functionality and low power consumption.

In one embodiment, processor 2600 is capable of executing a compiler, optimization, and/or translator code 2677 to compile, translate, and/or optimize application code 2676 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

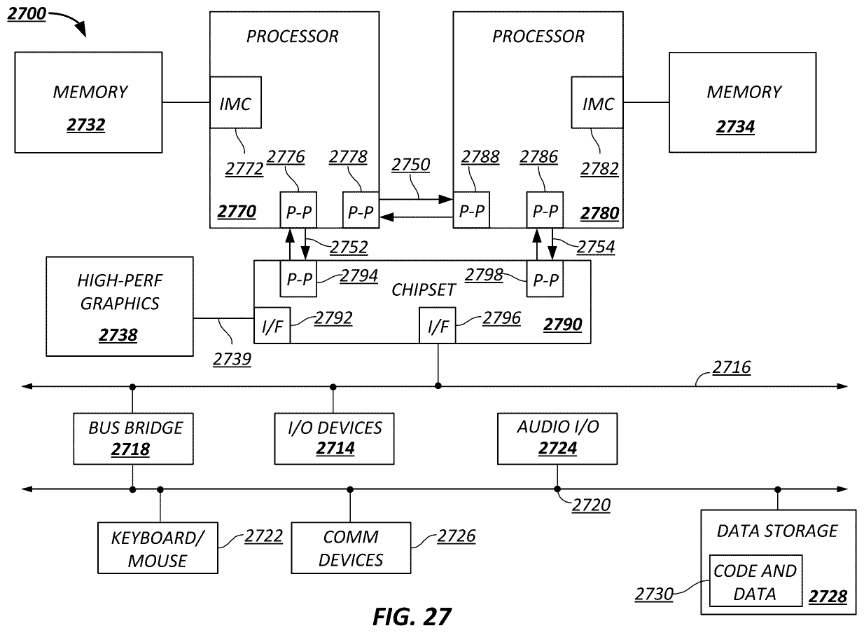

Referring now to FIG. 27, shown is a block diagram of a second system 2700 in accordance with an embodiment of the present disclosure. As shown in FIG. 27, multiprocessor system 2700 is a point-to-point interconnect system, and includes a first processor 2770 and a second processor 2780 coupled via a point-to-point interconnect 2750. Each of processors 2770 and 2780 may be some version of a processor. In one embodiment, 2752 and 2754 are part of a serial, point-to-point coherent interconnect fabric.

While shown with only two processors 2770, 2780, it is to be understood that the scope of the present disclosure is not so limited. In other embodiments, one or more additional processors may be present in a given processor.

Processors 2770 and 2780 are shown including integrated memory controller units 2772 and 2782, respectively. Processor 2770 also includes as part of its bus controller units point-to-point (P-P) interfaces 2776 and 2778; similarly, second processor 2780 includes P-P interfaces 2786 and 2788. Processors 2770, 2780 may exchange information via a point-to-point (P-P) interface 2750 using P-P interface circuits 2778, 2788. As shown in FIG. 27, IMCs 2772 and 2782 couple the processors to respective memories, namely a memory 2732 and a memory 2734, which may be portions of main memory locally attached to the respective processors.

Processors 2770, 2780 each exchange information with a chipset 2790 via individual P-P interfaces 2752, 2754 using point to point interface circuits 2776, 2794, 2786, 2798. Chipset 2790 also exchanges information with a high-performance graphics circuit 2738 via an interface circuit 2792 along a high-performance graphics interconnect 2739 (e.g., which may also incorporate the interconnect and debug reporting features described above).

A shared cache (not shown) may be included in either processor or outside of both processors; yet connected with the processors via P-P interconnect, such that either or both processors' local cache information may be stored in the shared cache if a processor is placed into a low power mode.

Chipset 2790 may be coupled to a first bus 2716 via an interface 2796. In one embodiment, first bus 2716 may be a Peripheral Component Interconnect (PCI) bus, or a bus such as a PCI Express bus or another third generation I/O interconnect bus, although the scope of the present disclosure is not so limited.

As shown in FIG. 27, various I/O devices 2714 are coupled to first bus 2716, along with a bus bridge 2718 which couples first bus 2716 to a second bus 2720. In one embodiment, second bus 2720 includes a low pin count (LPC) bus. Various devices are coupled to second bus 2720 including, for example, a keyboard and/or mouse 2722, communication devices 2727 and a storage unit 2728 such as a disk drive or other mass storage device which often includes instructions/code and data 2730, in one embodiment. Further, an audio I/O 2724 is shown coupled to second bus 2720. Note that other architectures are possible, where the included components and interconnect architectures vary. For example, instead of the point-to-point architecture of FIG. 27, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the solutions described above may be implemented in any portion of one or more of the interconnects illustrated or described below.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. The processor(s) may include any suitable processing unit, such as those based on x86, ARM, RISC-V, or other architectures. Examples include Intel® Core™ processors, AMD Ryzen® or EPYC® processors, Apple® M-series processors, Qualcomm® Snapdragon™ processors, or equivalents. The processor(s) may be part of a system-on-chip (SoC), system-in-package (SiP), or other integrated configurations. Other suitable processors now known or later developed may also be used. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via an SSD. However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by an SSD alone or as a disk, optical or other drive with an SSD cache. In some embodiments, the mass storage is implemented as an SSD or as an HDD along with a restore (RST) cache module. In various implementations, the HDD provides for storage of between 320 GB-4 terabytes (TB) and upward while the RST cache is implemented with an SSD having a capacity of 24 GB-256 GB. Note that such SSD cache may be configured as a single level cache (SLC) or multi-level cache (MLC) option to provide an appropriate level of responsiveness. In an SSD-only option, the module may be accommodated in various locations such as in a mSATA or NGFF slot. As an example, an SSD has a capacity ranging from 120 GB-1 TB.

While the concepts above have been described with respect to a limited number of embodiments, those skilled in the art will appreciate numerous modifications and variations therefrom. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and O's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The following examples pertain to embodiments in accordance with this Specification.

Example 1 is an apparatus including: a port to couple to another device over an interconnect, where the port includes circuitry to: generate a no operation (NOP) flit, where the NOP flit is encoded with debug information; and send the NOP flit on the interconnect.

Example 2 includes the subject matter of example 1, where the NOP flit is one of a plurality of NOP flit types supported in a protocol.

Example 3 includes the subject matter of example 2, where the plurality of NOP flit types include a debug NOP flit type, a vendor-defined NOP flit type, and an empty NOP flit type, where the NOP flit is of the debug NOP flit type.

Example 4 includes the subject matter of example 3, where the NOP includes a field to indicate that the NOP flit is of the debug NOP flit type.

Example 5 includes the subject matter of any one of examples 2-4, where the protocol includes a Peripheral Component Interconnect Express (PCIe)-based protocol.

Example 6 includes the subject matter of any one of examples 1-5, where the debug information is generated at one of a transaction layer or protocol layer of a protocol stack and describes attributes of the one of the transaction layer or the protocol layer.

Example 7 includes the subject matter of example 6, where the port includes logic to implement at least one of the transaction layer or the protocol layer.

Example 8 includes the subject matter of any one of examples 1-7, where the circuitry includes physical layer circuitry to generate the NOP flit.

Example 9 includes the subject matter of any one of examples 1-8, where the NOP flit includes a debug chunk and the debug information is encoded in the debug chunk.

Example 10 includes the subject matter of example 9, where the debug chunk is according to a defined debug chunk format, and the defined debug chunk format defines a debug chunk header and a debug chunk payload.

Example 11 includes the subject matter of example 10, where the NOP flit includes a plurality of a debug chunks according to the defined debug chunk format.

Example 12 is a method including: identifying debug information from a layer in a protocol stack, where the protocol stack governs a link on an interconnect; generating, at a physical layer in the protocol stack, a no operation (NOP) flit, where the NOP flit is encoded with the debug information; and end the NOP flit over the interconnect.

Example 13 includes the subject matter of example 12, further including recording the NOP flit to correlate the debug information with a portion of a data stream associated with the NOP flit.

Example 14 includes the subject matter of any one of examples 12-13, where the NOP flit is one of a plurality of NOP flit types supported in a protocol.

Example 15 includes the subject matter of example 14, where the plurality of NOP flit types include a debug NOP flit type, a vendor-defined NOP flit type, and an empty NOP flit type, where the NOP flit is of the debug NOP flit type.

Example 16 includes the subject matter of example 15, where the NOP includes a field to indicate that the NOP flit is of the debug NOP flit type.

Example 17 includes the subject matter of any one of examples 14-16, where the protocol includes a Peripheral Component Interconnect Express (PCIe)-based protocol.

Example 18 includes the subject matter of any one of examples 12-17, where the debug information is generated at one of a transaction layer or protocol layer of a protocol stack and describes attributes of the one of the transaction layer or the protocol layer.

Example 19 includes the subject matter of example 18, where the port includes logic to implement at least one of the transaction layer or the protocol layer.

Example 20 includes the subject matter of any one of examples 12-19, where the circuitry includes physical layer circuitry to generate the NOP flit.

Example 21 includes the subject matter of any one of examples 12-20, where the NOP flit includes a debug chunk and the debug information is encoded in the debug chunk.

Example 22 includes the subject matter of example 21, where the debug chunk is according to a defined debug chunk format, and the defined debug chunk format defines a debug chunk header and a debug chunk payload.

Example 23 includes the subject matter of example 22, where the NOP flit includes a plurality of a debug chunks according to the defined debug chunk format.

Example 24 is a system including: a first device and a second device coupled to the first device by an interconnect, where the second device includes a port to couple to the interconnect, where the port includes circuitry to: generate a no operation (NOP) flit, where the NOP flit is encoded with debug information; and send the NOP flit on the interconnect to the first device.

Example 25 includes the subject matter of example 24, where the NOP flit is one of a plurality of NOP flit types supported in a protocol.

Example 26 includes the subject matter of example 25, where the plurality of NOP flit types include a debug NOP flit type, a vendor-defined NOP flit type, and an empty NOP flit type, where the NOP flit is of the debug NOP flit type.

Example 27 includes the subject matter of example 26, where the NOP includes a field to indicate that the NOP flit is of the debug NOP flit type.

Example 28 includes the subject matter of any one of examples 25-27, where the protocol includes a Peripheral Component Interconnect Express (PCIe)-based protocol.

E Example 29 includes the subject matter of any one of examples 24-28, where the debug information is generated at one of a transaction layer or protocol layer of a protocol stack and describes attributes of the one of the transaction layer or the protocol layer.

Example 30 includes the subject matter of example 29, where the port includes logic to implement at least one of the transaction layer or the protocol layer.

Example 31 includes the subject matter of any one of examples 24-30, where the circuitry includes physical layer circuitry to generate the NOP flit.

Example 32 includes the subject matter of any one of examples 24-31, where the NOP flit includes a debug chunk and the debug information is encoded in the debug chunk.

Example 33 includes the subject matter of example 32, where the debug chunk is according to a defined debug chunk format, and the defined debug chunk format defines a debug chunk header and a debug chunk payload.

Example 34 includes the subject matter of example 33, where the NOP flit includes a plurality of a debug chunks according to the defined debug chunk format.

Example 35 includes the subject matter of any one of examples 24-34, where at least one of the first device or the second device includes a host processor device.

Example 36 includes the subject matter of any one of examples 24-35, where at least one of the first device or the second device includes a graphics processor device.

Example 37 includes the subject matter of any one of examples 24-35, further including a protocol analyzer configured to receive the NOP flit and process the debug information included in the NOP flit.

Example 38 is an apparatus including a protocol analyzer configured to receive a no operation (NOP) flit sent on a link, where the NOP flit is encoded with debug information; process the debug information; and perform one or more debug tasks using the debug information.

Example 39 includes the subject matter of example 38, where the NOP flit includes the features in any one of examples 2-11.

Example 40 includes the subject matter of any one of examples 1-11, where the other device includes a protocol analyzer.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a port to couple to another device over an interconnect, wherein the port comprises circuitry to:
generate a no operation (NOP) flit, wherein the NOP flit is encoded with debug information; and
send the NOP flit on the interconnect.

2. The apparatus of claim 1, wherein the NOP flit is one of a plurality of NOP flit types supported in a protocol.

3. The apparatus of claim 2, wherein the plurality of NOP flit types comprise a debug NOP flit type, a vendor-defined NOP flit type, and an empty NOP flit type, wherein the NOP flit is of the debug NOP flit type.

4. The apparatus of claim 3, wherein the NOP comprises a field to indicate that the NOP flit is of the debug NOP flit type.

5. The apparatus of claim 2, wherein the protocol comprises a Peripheral Component Interconnect Express (PCIe)-based protocol.

6. The apparatus of claim 1, wherein the debug information is generated at one of a transaction layer or protocol layer of a protocol stack and describes attributes of the one of the transaction layer or the protocol layer.

7. The apparatus of claim 6, wherein the port comprises logic to implement at least one of the transaction layer or the protocol layer.

8. The apparatus of claim 1, wherein the circuitry comprises physical layer circuitry to generate the NOP flit.

9. The apparatus of claim 1, wherein the NOP flit comprises a debug chunk and the debug information is encoded in the debug chunk.

10. The apparatus of claim 9, wherein the debug chunk is according to a defined debug chunk format, and the defined debug chunk format defines a debug chunk header and a debug chunk payload.

11. The apparatus of claim 10, wherein the NOP flit comprises a plurality of a debug chunks according to the defined debug chunk format.

12. A method comprising:
identifying debug information from a layer in a protocol stack, wherein the protocol stack governs a link on an interconnect;
generating, at a physical layer in the protocol stack, a no operation (NOP) flit, wherein the NOP flit is encoded with the debug information; and
ending the NOP flit over the interconnect.

13. The method of claim 12, further comprising recording the NOP flit to correlate the debug information with a portion of a data stream associated with the NOP flit.

14. The method of claim 12, further comprising generating the debug information at one of a transaction layer or protocol layer of the protocol stack, wherein the debug information describes attributes of the one of the transaction layer or the protocol layer.

15. The method of claim 12, wherein the NOP flit comprises a plurality of a debug chunk payloads.

16. A system comprising:
a first device; and
a second device coupled to the first device by an interconnect, wherein the second device comprises a port to couple to the interconnect, and the port comprises circuitry to:
generate a no operation (NOP) flit, wherein the NOP flit is encoded with debug information; and
send the NOP flit on the interconnect to the first device.

17. The system of claim 16, wherein the port comprises circuitry to generate a plurality of different NOP flit types, and the plurality of NOP flit types comprise: a debug NOP flit type, a vendor-defined NOP flit type, and an empty NOP flit type, wherein the NOP flit is of the debug NOP flit type.

18. The system of claim 16, wherein the debug information is generated at one of a transaction layer or protocol layer of a protocol stack and describes attributes of the one of the transaction layer or the protocol layer, wherein the port comprises logic to implement at least one of the transaction layer or the protocol layer.

19. The system of claim 16, wherein at least one of the first device or the second device comprises a host processor device.

20. The system of claim 16, wherein at least one of the first device or the second device comprises a graphics processor device.
